(19) United States
(12) Patent Application Publication
(10) Pub. No.: US 2026/0161366 A1
(43) Pub. Date: Jun. 11, 2026

(54) MIGRATING LEGACY AUTOMATION TOOLS USED IN NETWORK MONITORING SYSTEMS

(71) Applicant: AT&T Intellectual Property I, L.P., Atlanta, GA (US)

(72) Inventors: Sudharani Parvangada, Manalapan, NJ (US); Prafulla Verma, Holmdel, NJ (US); Divakaran Dhanasekaran, Matawan, NJ (US)

(21) Appl. No.: 18/974,767

(22) Filed: Dec. 9, 2024

(51) Int. Cl. G06F 8/30

(52) U.S. Cl. CPC G06F 8/31

(57) ABSTRACT

A method includes cloning a repository of source code associated with a network monitoring and analysis tool, the repository containing a plurality of source code files, identifying a plurality of static URLs contained in a source code file, identifying, for each static URL, a first set of external interfaces with which the static URL interacts, identifying a plurality of dynamic URLs generated by a graphical user interface tool contained in the source code file, identifying, for each dynamic URL, a second set of external interfaces with which the dynamic URL interacts, generating, using a language model, a report describing the first and second sets of external interfaces, and generating, based on the report, a plan for migrating the network monitoring and analysis tool to a network service assurance system platform, wherein the plan accounts for the first set of external interfaces and the second set of external interfaces.

The present disclosure relates generally to wireless networks, and relates more particularly to devices, non-transitory computer-readable media, and methods for migrating legacy automation tools used in network monitoring systems.

### BACKGROUND

In wireless networking, a network monitoring and analysis (NMA) system is responsible for monitoring an enterprise's wireless network to ensure optimal availability and performance of the network. The NMA system may use alarm processing rules to generate a singular, actionable root cause trouble ticket for alarms that are generated within the network (where the alarms may indicate the presence of conditions, such as hardware failures, key performance indicator degradations, or the like, that may lead to sub-optimal network performance).

### SUMMARY

In one example, the present disclosure describes a device, computer-readable medium, and method for migrating legacy automation tools used in network monitoring systems. For instance, in one example, a method performed by a processing system including at least one processor includes cloning a repository of source code associated with a network monitoring and analysis tool, wherein the repository contains a plurality of source code files, identifying a plurality of static uniform resource locators contained in a source code file of the plurality of source code files, identifying, for each static uniform resource locator of the plurality of static uniform resource locators, a first set of external interfaces with which the each static uniform resource locator interacts, identifying a plurality of dynamic uniform resource locators generated by a graphical user interface tool contained in the source code file, identifying, for each dynamic uniform resource locator of the plurality of dynamic uniform resource locators, a second set of external interfaces with which the each dynamic uniform resource locator interacts, generating, using a language model, a report describing the first set of external interfaces and the second set of external interfaces, and generating, based on the report, a plan for migrating the network monitoring and analysis tool to a network service assurance system platform, wherein the plan accounts for the first set of external interfaces and the second set of external interfaces.

In another example, a non-transitory computer-readable medium stores instructions which, when executed by the processing system, cause the processing system to perform operations. The operations include cloning a repository of source code associated with a network monitoring and analysis tool, wherein the repository contains a plurality of source code files, identifying a plurality of static uniform resource locators contained in a source code file of the plurality of source code files, identifying, for each static uniform resource locator of the plurality of static uniform resource locators, a first set of external interfaces with which the each static uniform resource locator interacts, identifying a plurality of dynamic uniform resource locators generated by a graphical user interface tool contained in the source code file, identifying, for each dynamic uniform resource locator of the plurality of dynamic uniform resource locators, a second set of external interfaces with which the each dynamic uniform resource locator interacts, generating, using a language model, a report describing the first set of external interfaces and the second set of external interfaces, and generating, based on the report, a plan for migrating the network monitoring and analysis tool to a network service assurance system platform, wherein the plan accounts for the first set of external interfaces and the second set of external interfaces.

In another example, a system includes a processing system including at least one processor and a non-transitory computer-readable medium storing instructions which, when executed by the processing system, cause the processing system to perform operations. The operations include cloning a repository of source code associated with a network monitoring and analysis tool, wherein the repository contains a plurality of source code files, identifying a plurality of static uniform resource locators contained in a source code file of the plurality of source code files, identifying, for each static uniform resource locator of the plurality of static uniform resource locators, a first set of external interfaces with which the each static uniform resource locator interacts, identifying a plurality of dynamic uniform resource locators generated by a graphical user interface tool contained in the source code file, identifying, for each dynamic uniform resource locator of the plurality of dynamic uniform resource locators, a second set of external interfaces with which the each dynamic uniform resource locator interacts, generating, using a language model, a report describing the first set of external interfaces and the second set of external interfaces, and generating, based on the report, a plan for migrating the network monitoring and analysis tool to a network service assurance system platform, wherein the plan accounts for the first set of external interfaces and the second set of external interfaces.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for migrating legacy automation tools used in network monitoring systems may operate;

FIG. 2 illustrates a flowchart of an example method for migrating legacy automation tools used in network monitoring systems, according to examples of the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for migrating legacy automation tools used in network monitoring systems. As discussed above, in wireless networking, a network monitoring and analysis (NMA) system is responsible for monitoring an enterprise's wireless network to ensure optimal availability and performance of the network. The NMA system may use alarm processing rules to generate a singular, actionable root cause trouble ticket for alarms that are generated within the network (where the alarms may indicate the presence of conditions, such as hardware failures, key performance indicator degradations, or the like, that may lead to sub-optimal network performance).

There is interest in transitioning the NMA function (i.e., of generating root cause trouble tickets) toward the broader scope of a network service assurance system (NSAS). Part of this transition involves migrating legacy automation tools from an NMA system to the NSAS platform. However, migrating these legacy tools is not a straightforward process. For one, the existing NMA infrastructure may be outdated, approaching the end of its service life, and/or no longer supported by the vendor. This presents a risk to operational stability and reliability and increases maintenance costs due to frequent breakdowns and the potential for a prolonged downtime.

Furthermore, the legacy NMA tools may be proprietary or vendor-locked, which limits flexibility and makes integration with next-generation systems and adoption of best-of-breed solutions difficult. Dependence on specific vendors may constrain an enterprise's ability to negotiate terms, adopt new technologies, and innovate, which may, in turn, lead to higher costs and reduced competitiveness.

In addition, legacy NMA tools tend not to be easily scalable or adaptable to new requirements, which hinders the enterprise's ability to grow and respond to evolving market needs. In other words, difficulty in scaling operations, integrating new features, and expanding into new markets may lead to revenue loss and missed opportunities for the enterprise.

Outdated NMA tools may also contribute to operational inefficiencies, such as slow processes, manual interventions, and high operational costs. Reduced operational efficiency contributes to higher costs and slower service delivery, which negatively affects customer satisfaction and overall business performance.

While various attempts have been made to make the integration of legacy NMA tools with next-generation platforms a smoother process, these attempts all come with different limitations such as a high cost of implementation, dependencies on specific vendors, labor and/or time intensiveness, susceptibility to error, and the like.

Examples of the present disclosure integrate static and dynamic analysis techniques to facilitate the migration of legacy automation tools used in NMA to a target next-generation platform, such as a cloud-based NSAS platform. Examples of the present disclosure leverage techniques including dynamic application security testing (DAST) and language models (e.g., large language models, small language models, and the like) to enable seamless integration of legacy automation tools with next-generation platforms. The disclosed approach addresses the core challenges of migrating the legacy automation tools more effectively, improving long-term operational efficiency, scalability, and flexibility.

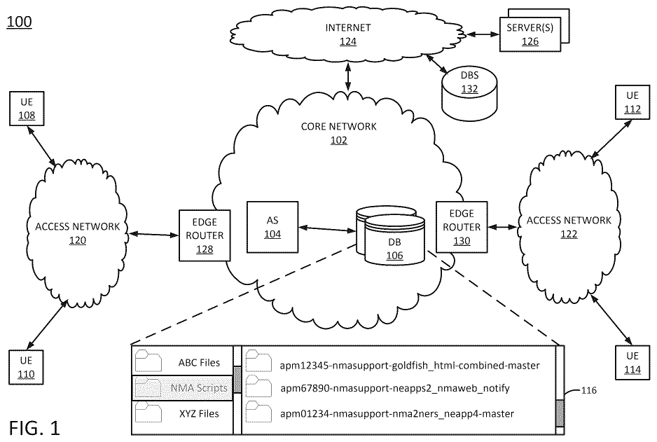

More specifically, examples of the present disclosure analyze the NMA script repositories (of which there may be five hundred or more) associated with a legacy NMA system to identify the external interfaces that interact with the scripts, as well as the inputs and outputs of those external interfaces. Knowing the external interfaces and their inputs and outputs allows the legacy NMA tools to be integrated into a next-generation NSAS platform in a seamless manner. These and other advantages of the present disclosure are discussed in greater detail below with in connection with FIGS. 1-3.

To further aid in understanding the present disclosure, FIG. 1 illustrates an example system 100 in which examples of the present disclosure for migrating legacy automation tools used in network monitoring systems may operate. In one example, the system may comprise or include all or part of a network monitoring and analysis system. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

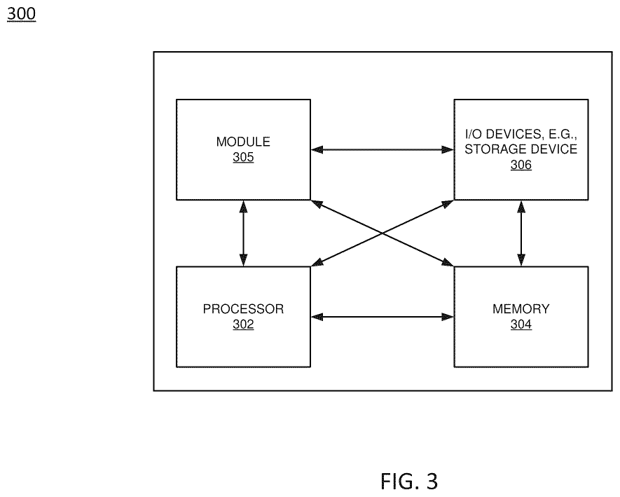

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 300 depicted in FIG. 3, and may be configured as described below. For example, the user endpoint devices 108, 110, 112, and 114 may each comprise a smart phone, a tablet computer, a laptop computer, a gaming device, a wearable smart device (e.g., a smart watch, a head mounted display, or the like), an IoT device, a connected vehicle, a bank or cluster of such devices, and the like.

In one example, one or more servers 126 and one or more databases 132 may be accessible to user endpoint devices 108, 110, 112, and 114 via Internet 124 in general. The server(s) 126 and DBs 132 may be associated with Internet software applications and/or resources that may exchange data with the user endpoint devices 108, 110, 112, and 114 over the Internet 124. In one example, at least some of the servers 126 and DBs 132 may host applications that interact with NMA tools or automation scripts.

In accordance with the present disclosure, the AS 104 may be configured to provide one or more operations or functions in connection with examples of the present disclosure for migrating legacy automation tools used in network monitoring systems, as described herein. For instance, when an NMA system is migrated to an NSAS platform, the AS 104 may be configured to analyze the automation scripts for the NMA tool to identify all of the external interfaces with which the automation scripts interact and to recommend a plan to ensure those interactions are preserved in the migration to the NSAS platform.

The NMA automation scripts may be stored across a plurality of repositories, such as the DB(s) 106. In one example, the AS 104 may clone the DB(s) 106, analyze the directory structures of the DB(s) 106 (e.g., as shown in the inset 116 of FIG. 1), and analyze the automation scripts contained in the DB(s) 106 for all static and dynamic URLs referenced in the automation scripts. The AS 104 may engage one or more tools, including DAST tools, to determine all of the external interfaces associated with the static and dynamic URLs, as well as the inputs and outputs to those external interfaces. For instance, the AS 104 may run a DAST tool that populates the inputs of a graphical user interface (GUI) in the automation scripts with a plurality of dummy values, runs the GUI in a controlled environment with the dummy values, and determines what outputs are generated by the GUI (e.g., what external systems the GUI connects to).

In further examples, the AS 104 may run a language model that generates a report containing detailed information for the external interfaces (e.g., including inputs and outputs) with which the static and dynamic URLs interact. The information contained in this report may be used to generate a plan for migrating the NMA automatic scripts to an NSAS or other next-generation platforms in a manner that preserves those interactions.

The AS 104 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the DB 106 may comprise a physical storage device integrated with the AS 104 (e.g., a database server or a file server), or attached or coupled to the AS 104, in accordance with the present disclosure.

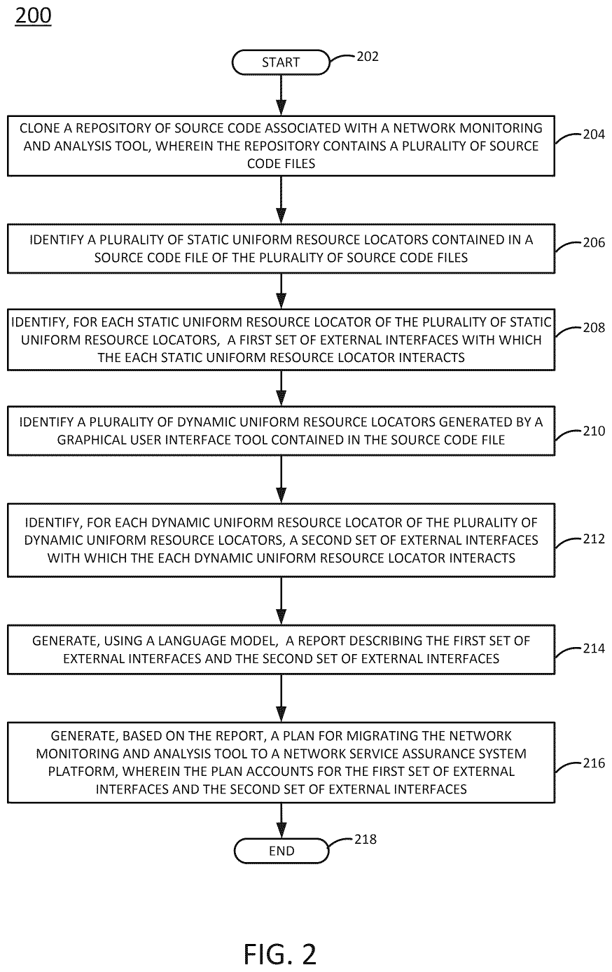

In one example, the AS 104 may load instructions into a memory, or one or more distributed memory units, and execute the instructions for migrating legacy automation tools used in network monitoring systems, as described herein. For instance, an example method for migrating legacy automation tools used in network monitoring systems is discussed in further detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

To further aid in understanding the present disclosure, FIG. 2 illustrates a flowchart of an example method 200 for migrating legacy automation tools used in network monitoring systems. In one example, the method 200 may be performed by the AS 104 or by another element of the core network 102 illustrated in FIG. 1. However, in other examples, the method 200 may be performed by another device, such as the computing system 300 of FIG. 3, discussed in further detail below. For the sake of discussion, the method 200 is described below as being performed by a processing system (where the processing system may comprise a component of the AS 104 or by another element of the core network 102, the computing system 300, or another device).

The method 200 begins in step 202 and proceeds to step 204. In step 204, the processing system may clone a repository of source code associated with a network monitoring and analysis tool, wherein the repository contains a plurality of source code files.

In one example, the NMA tool may be one of a plurality of NMA tools making up a legacy NMA system. Collectively, the plurality of NMA tools may be embodied in source code (e.g., automation scripts) that may be stored across hundreds of repositories. For instance, an example NMA system may be stored across eight hundred or more source code repositories. In one example, each of these source code repositories may resemble a folder having a directory structure, where each directory in the structure may contain a source code file.

In step 206, the processing system may identify a plurality of static uniform resource locators contained in a source code file of the plurality of source code files. In one example, a code written in the Python programming language may be run against the repository to scan the plurality of source code files and identify any static URLs contained in the source code. In one example, the plurality of static URLs may be cleaned to remove delimiters and other extraneous characters.

In step 208, the processing system may identify, for each static uniform resource locator of the plurality of static uniform resource locators, a first set of external interfaces with which the each static uniform resource locator interacts. In one example, the plurality of static URLs may be sorted to facilitate identifying the first set of external interfaces. In one example, the first set of external interfaces may comprise any application programming interfaces (APIs) that link to other source code files or other systems outside of the source code file.

In step 210, the processing system may identify a plurality of dynamic uniform resource locators generated by a graphical user interface tool contained in the source code file. In one example, dynamic URLs are not contained explicitly in the source code file, but are generated at runtime by a graphical user interface (GUI) tool, if the source code file contains a GUI file. If the source code file contains a GUI tool, the processing system may engage a DAST tool (e.g., such as might be used to scan for security violations such as structured language query (SQL) injections, cross-site scripting, vulnerabilities, package dependencies, and the like) to detect dynamic interactions of the source code file by populating the inputs of the GUI tool with dummy values (e.g., simulated or test), running the GUI tool in a controlled environment with the dummy values (to simulate run-time usage), and reviewing the resultant interactions. In one example, the WEBDRIVER tool in the Selenium automation framework may be run in conjunction with the Python code and the CHROMEDRIVER server from Google LLC™ to run the GUI tool.

In step 212, the processing system may identify, for each dynamic uniform resource locator of the plurality of dynamic uniform resource locators, a second set of external interfaces with which each dynamic uniform resource locator interacts. In one example, the second set of external interfaces may be identified in a report generated by the DAST tool. Typically, a DAST tool will report only security violations in scanned source code, but in this case the interactions resulting from population of the GUI tool inputs with dummy values may comprise a list of all URLs traversed by the source code file (not just the URLs associated with security violations).

In step 214, the processing system may generate, using a language model, a report describing the first set of external interfaces and the second set of external interfaces. In one example, the language model may be a large language model (LLM), a small language model (SLM), or any other types of language model. For instance, in one example, the ASK AT&T® generative artificial intelligence tool may be executed to take as input the first set of external interfaces and the second set of external interfaces and to generate as an output detailed descriptions of the external interfaces with which the source code file interacts. These detailed descriptions may interpret the complex interactions of the source code file and may include comprehensive API documentation for the source code file, including inputs and outputs.

In step 216, the processing system may generate, based on the report, a plan for migrating the network monitoring and analysis tool to a network service assurance system platform, wherein the plan accounts for the first set of external interfaces and the second set of external interfaces. For instance, the plan to migrate the NMA tool may be adjusted to ensure that, when migrated to the NSAS platform, the NMA tool continues to interact with the same external interfaces in a manner that is consistent with the NMA tool's interactions prior to migration. The method 200 may end in step 218.

It should be noted, however, that the method 200 may be repeated for each source code file in the repository. Moreover, the method 200 may be repeated for additional repositories of source code associated with other NMA tools to be migrated. For instance, a full NMA system may be embodied in source code contained in hundreds of code repositories.

Thus, examples of the present disclosure integrate both static and dynamic analysis of the source code files for NMA tools for URL discovery, resulting in a more holistic understanding of the NMA tools'interactions with external systems in comparison to approaches that utilize either static or dynamic analysis in isolation (which tends to overlook critical interactions with external systems).

The use of tools like DAST and language models automates the discovery of both static and dynamic URLs, which ensures a smoother migration of legacy automation scripts to a next-generation platform by reducing the occurrence of errors that are common in manual migration techniques. Smoother migration will result in a better operational efficiency and reduced downtime, as well as reduced dependency on specific vendors. The disclosed approach is highly scalable, which allows for easier integration and future upgrades of the next-generation platform.

Although not expressly specified above, one or more steps of the method 200 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above-described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, any one or more of the servers 104 or 126 or edge routers 128 or 130 of FIG. 1 (such as might be used to perform the method 200) could be implemented as illustrated in FIG. 3. As depicted in FIG. 3, the system 300 comprises a hardware processor element 302, a memory 3504, a module 305 for migrating legacy automation tools used in network monitoring systems, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for migrating legacy automation tools used in network monitoring systems may include circuitry and/or logic for scanning source code files associated with NMA automation scripts for static and dynamic URLs. The input/output devices 306 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for migrating legacy automation tools used in network monitoring systems can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above-described method(s) can be perceived as a programmed processor or a specialized processor. As such, the present module 305 for migrating legacy automation tools used in network monitoring systems (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
cloning, by a processing system including at least one processor, a repository of source code associated with a network monitoring and analysis tool, wherein the repository contains a plurality of source code files;
identifying, by the processing system, a plurality of static uniform resource locators contained in a source code file of the plurality of source code files;
identifying, by the processing system for each static uniform resource locator of the plurality of static uniform resource locators, a first set of external interfaces with which the each static uniform resource locator interacts;
identifying, by the processing system, a plurality of dynamic uniform resource locators generated by a graphical user interface tool contained in the source code file;
identifying, by the processing system for each dynamic uniform resource locator of the plurality of dynamic uniform resource locators, a second set of external interfaces with which the each dynamic uniform resource locator interacts;
generating, by the processing system using a language model, a report describing the first set of external interfaces and the second set of external interfaces; and
generating, by the processing system based on the report, a plan for migrating the network monitoring and analysis tool to a network service assurance system platform, wherein the plan accounts for the first set of external interfaces and the second set of external interfaces.

2. The method of claim 1, wherein the plurality of source code files comprises a plurality of automation scripts for the network monitoring and analysis tool.

3. The method of claim 2, wherein the repository is one of a plurality of repositories across which the plurality of automation scripts is stored.

4. The method of claim 1, wherein the identifying the plurality of static uniform resource locators is performed by scanning the source code file with a python script.

5. The method of claim 1, wherein the plurality of static uniform resource locators is cleaned to remove delimiters.

6. The method of claim 1, wherein the plurality of static uniform resource locators is sorted to facilitate the identifying the first set of external interfaces.

7. The method of claim 1, wherein the plurality of dynamic uniform resource locators comprises uniform resource locators that are generated by the graphical user interface tool at runtime.

8. The method of claim 7, wherein the identifying the plurality of dynamic uniform resource locators is performed by running a dynamic application security testing tool against the source code file.

9. The method of claim 8, wherein the dynamic application security testing tool populates inputs of the graphical user interface tool with dummy values and runs the graphical user interface tool with the dummy values to observe resultant interactions.

10. The method of claim 1, wherein the language model is one of: a large language model or a small language model.

11. The method of claim 1, wherein the report documents inputs and outputs of the source code file.

12. The method of claim 1, wherein the plan preserves interactions of the network monitoring and analysis tool with the first set of external interfaces and the second set of external interfaces after the migrating.

13. The method of claim 1, wherein the identifying the plurality of static uniform resource locators, the identifying the first set of external interfaces, the identifying the plurality of dynamic uniform resource locators, the identifying the second set of external interfaces, the generating the report, and the generating the plan is repeated for each source code file of the plurality of source code files.

14. A non-transitory computer-readable medium storing instructions which, when executed by a processing system including at least one processor, cause the processing system to perform operations, the operations comprising:
cloning a repository of source code associated with a network monitoring and analysis tool, wherein the repository contains a plurality of source code files;
identifying a plurality of static uniform resource locators contained in a source code file of the plurality of source code files;
identifying, for each static uniform resource locator of the plurality of static uniform resource locators, a first set of external interfaces with which the each static uniform resource locator interacts;
identifying a plurality of dynamic uniform resource locators generated by a graphical user interface tool contained in the source code file;
identifying, for each dynamic uniform resource locator of the plurality of dynamic uniform resource locators, a second set of external interfaces with which the each dynamic uniform resource locator interacts;
generating, using a language model, a report describing the first set of external interfaces and the second set of external interfaces; and
generating, based on the report, a plan for migrating the network monitoring and analysis tool to a network service assurance system platform, wherein the plan accounts for the first set of external interfaces and the second set of external interfaces.

15. The non-transitory computer-readable medium of claim 14, wherein the plurality of source code files comprises a plurality of automation scripts for the network monitoring and analysis tool.

16. The non-transitory computer-readable medium of claim 14, wherein the identifying the plurality of static uniform resource locators is performed by scanning the source code file with a python script.

17. The non-transitory computer-readable medium of claim 14, wherein the plurality of dynamic uniform resource locators comprises uniform resource locators that are generated by the graphical user interface tool at runtime.

18. The non-transitory computer-readable medium of claim 17, wherein the identifying the plurality of dynamic uniform resource locators is performed by running a dynamic application security testing tool against the source code file.

19. The non-transitory computer-readable medium of claim 18, wherein the dynamic application security testing tool populates inputs of the graphical user interface tool with dummy values and runs the graphical user interface tool with the dummy values to observe resultant interactions.

20. A system comprising:
a processing system including at least one processor; and
a non-transitory computer-readable medium storing instructions which, when executed by the processing system, cause the processing system to perform operations, the operations comprising:
cloning a repository of source code associated with a network monitoring and analysis tool, wherein the repository contains a plurality of source code files;
identifying a plurality of static uniform resource locators contained in a source code file of the plurality of source code files;
identifying, for each static uniform resource locator of the plurality of static uniform resource locators, a first set of external interfaces with which the each static uniform resource locator interacts;
identifying a plurality of dynamic uniform resource locators generated by a graphical user interface tool contained in the source code file;
identifying, for each dynamic uniform resource locator of the plurality of dynamic uniform resource locators, a second set of external interfaces with which the each dynamic uniform resource locator interacts;
generating, using a language model, a report describing the first set of external interfaces and the second set of external interfaces; and
generating, based on the report, a plan for migrating the network monitoring and analysis tool to a network service assurance system platform, wherein the plan accounts for the first set of external interfaces and the second set of external interfaces.
